(19) United States
(12) Patent Application Publication
(10) Pub. No.: US 2011/0142146 A1
(43) Pub. Date: Jun. 16, 2011

(54) MULTI CARRIER SYSTEM AND METHOD FOR RECEIVING MULTI CARRIER

(75) Inventor: Hyoung Oh BAE, Daejeon (KR)

(73) Assignee: Electronics and Telecommunications Research Institute, Daejeon (KR)

(21) Appl. No.: 12/906,541

(22) Filed: Oct. 18, 2010

(30) Foreign Application Priority Data
Dec. 15, 2009 (KR) 10-2009-0124701

(51) Int. Cl. H04L 27/28

(52) U.S. Cl. 375/260

(57) ABSTRACT

Provided are a multi-carrier system and a method for receiving a multi-carrier. The multi-carrier system may include a transformation unit to transform an input signal from a time domain to a frequency domain, a signal accumulation unit to accumulate a magnitude of the input signal in a predetermined accumulation interval unit, and to count a number of overflows based on the accumulated magnitude of the input signal, a signal level determination unit to generate bit shift information for adjusting a level of the transformed input signal based on the counted number of overflows, and a signal level adjustment unit to adjust the level of the transformed input signal based on the generated bit shift information.

### CROSS-REFERENCE TO RELATED APPLICATION

This application claims the benefit of Korean Patent Application No. 10-2009-0124701, filed on Dec. 15, 2009, in the Korean Intellectual Property Office, the disclosure of which is incorporated herein by reference.

### BACKGROUND

1. Field of the Invention

The present invention relates to a multi-carrier system and a method for receiving a multi-carrier, and more particularly, to a multi-carrier system and a method for receiving a multi-carrier which may reduce a hardware resource.

2. Description of the Related Art

An Orthogonal Frequency Division Multiplexing (OFDM) system, that is, a type of a multi-carrier system may perform a symbol mapping using orthogonality between sub-carriers. In this instance, the OFDM system may transmit signals by performing a sub-carrier mapping and an Inverse Fast Fourier Transform (IFFT). Also, the OFDM system may perform an FFT on received signals.

The OFDM system may use a plurality of sub-carriers. Accordingly, signals where the IFFT is performed may have a high Peak to Average Power Ratio (PAPR). In this instance, when receiving OFDM signals and performing an Analog to Digital (AD) conversion on the received OFDM signals, a number of bits of signals converted to digital may increase. Also, along with an increase in the number of bits of the signals, a significant amount of hardware resources for processing the OFDM signal may be used. For example, the hardware resources may include a multiplier within a field programmable gate array (FPGA), a flip-flop, a memory, and the like.

The multi-carrier system may reduce the PAPR using a signal distortion scheme, an coding scheme, a scrambling scheme, and the like. In this instance, when using the signal distortion scheme, the encoding scheme, and the scrambling scheme, a performance deterioration may occur due to a nonlinear-distortion of a signal. Also, a significant amount of the hardware resources may be used for processing multi-carrier signals, and a processing time may increase.

Accordingly, there is a demand for a scheme that may reduce processing time while reducing hardware resource used for processing the multi-carrier signal.

### SUMMARY

An aspect of the present invention provides a multi-carrier system and a method for receiving a multi-carrier which may reduce a hardware resource.

According to an aspect of the present invention, there is provided a multi-carrier system, including: a transformation unit to transform an input signal from a time domain to a frequency domain; a signal accumulation unit to accumulate a magnitude of the input signal in a predetermined accumulation interval unit, and to count a number of overflows based on the accumulated magnitude of the input signal; a signal level determination unit to generate bit shift information for adjusting a level of the transformed input signal based on the counted number of overflows; and a signal level adjustment unit to adjust the level of the transformed input signal based on the generated bit shift information.

The signal accumulation unit may comprise an accumulation unit to accumulate the magnitude of the input signal in the predetermined accumulation interval unit; and an overflow detection unit to count the number of overflows obtained when the accumulated magnitude of the input signal exceeds an overall capacity of the accumulation unit.

The signal accumulation unit may accumulate the magnitude of the input signal using a single adder.

The signal level determination unit may generate the bit shift information to enable the bit shift information to have a negative number along with a reduction in the counted number of overflows, and to enable the bit shift information to have a positive number along with an increase in the counted number of overflows.

The transformation unit may transform the input signal from the time domain to the frequency domain by performing a fast Fourier transform (FFT) on the input signal, and the signal level adjustment unit may adjust a level of an FFT signal where the FFT is performed on the input signal.

In this instance, since the input signal needs to be accumulated for the predetermined accumulation interval to determine a level of the input signal, a buffering of the input signal may be used for the predetermined accumulation interval. Also, the signal level adjustment unit may be positioned in a rear end of the transformation unit that is used in a multi-carrier system, thereby preventing a memory resource from being additionally used.

According to an aspect of the present invention, there is provided a method for receiving a multi-carrier, the method including: transforming an input signal from a time domain to a frequency domain; accumulating a magnitude of the input signal in a predetermined accumulation interval unit; counting a number of overflows based on the accumulated magnitude of the input signal; generating bit shift information for adjusting a level of the transformed input signal based on the counted number of overflows; and adjusting the level of the transformed input signal based on the generated bit shift information.

Additional aspects, features, and/or advantages of the invention will be set forth in part in the description which follows and, in part, will be apparent from the description, or may be learned by practice of the invention.

### EFFECT

According to embodiments of the present invention, it may be possible to reduce demands on hardware resources by accumulating a magnitude of a signal and by adjusting a signal level.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of a multi-carrier system according to an embodiment of the present invention;

FIG. 2 is a diagram used for describing an operation where an input signal is accumulated according to an embodiment of the present invention;

FIG. 3 is a diagram used for describing a number of overflows and Least Significant Bit (LSB) information according to an embodiment of the present invention;

FIG. 4 is a diagram used for describing an operation where a level of a signal is adjusted in accordance with LSB information according to an embodiment of the present invention; and

FIG. 5 is a flowchart illustrating operations of a multi-carrier system according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

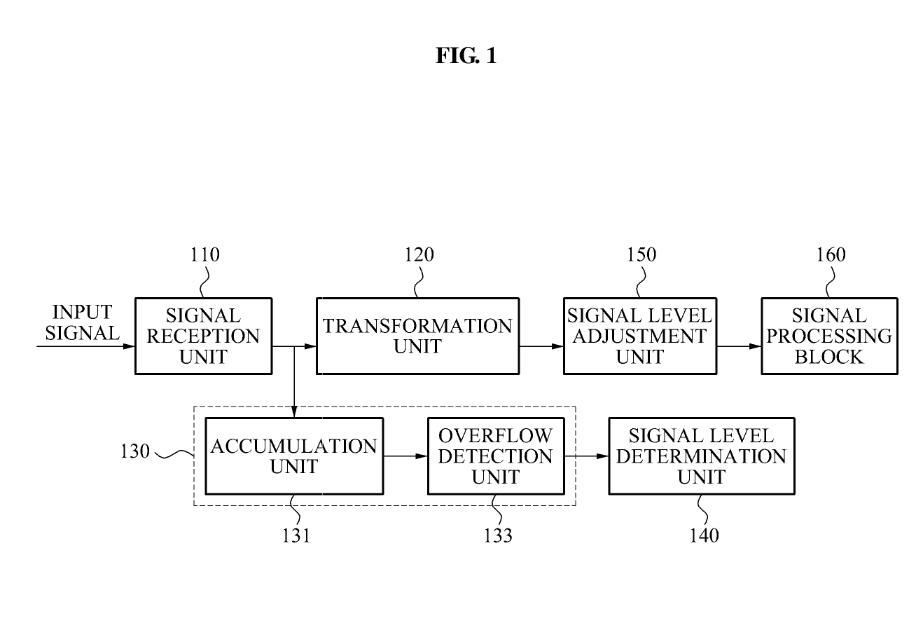

FIG. 1 is a block diagram illustrating a configuration of a multi-carrier system 100 according to an embodiment of the present invention.

Referring to FIG. 1, the multi-carrier system 100 includes a signal reception unit 110, a transformation unit 120, a signal accumulation unit 130, a signal level determination unit 140, a signal level adjustment unit 150, and a signal processing block 160.

The signal reception unit 110 may receive signals transmitted from a system transmitting a multi-carrier. For example, an input signal inputted to the signal reception unit 110 may be an Orthogonal Frequency Division Multiplexing (OFDM) signal, that is, a multi-carrier signal.

The transformation unit 120 may transform the input signal inputted to the signal reception unit 110 from a time domain to a frequency domain. In this instance, the transformation unit 120 may perform a Fast Fourier Transform (FFT) on the input signal to transform the input signal from the time domain to the frequency domain.

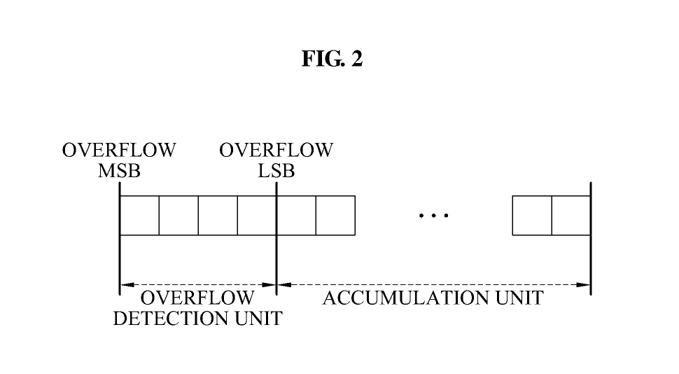

The signal accumulation unit 130 may sequentially accumulate a magnitude of the input signal transmitted to the signal reception unit 110. In this instance, the signal accumulation unit 130 may include an accumulation unit 131 and an overflow detection unit 133. Also, the signal accumulation unit 130 may include a bit accumulator that may accumulate bits, as illustrated in FIG. 2.

The accumulation unit 131 may accumulate the input signals in an accumulation interval unit, starting from an accumulation starting point in time. Here, the accumulation starting point may be predetermined based on a frame structure of a pilot signal or a preamble signal. Also, the accumulation interval may be predetermined so that a value of the accumulated signals that is measured based on the frame structure of the pilot signal or the preamble signal has representativeness. In this instance, the accumulation unit 131 may accumulate the magnitude of the input signal after an accumulated value is initialized as ‘0’.

For example, when the accumulation interval is predetermined as a symbol interval including a plurality of sub-carriers, the accumulation unit 131 may sequentially accumulate input signals transmitted to the signal reception unit 110 for the symbol interval. The accumulation unit 131 may calculate using an absolute value of the input signal. Specifically, the accumulation unit 131 may initialize the accumulation value as ‘0’ for each symbol interval, and calculate an accumulated value of absolute values obtained in the symbol interval unit. Using the absolute values, values corresponding to magnitudes of signals that do not have a sign may be accumulated.

In this instance, the accumulation unit 131 may accumulate the magnitude of the input signal by adding up an absolute value of each symbol using an adder.

The overflow detection unit 133 may count a number of overflows occurring when the accumulated magnitude of the input signal exceeds an overall capacity of the accumulation unit 131. For example, the overall capacity of the accumulation unit 131 may be a number of bits where bits of the input signal are sequentially accumulated. More specifically, as illustrated in FIG. 2, a bit length of an overflow Most Significant Bit (MSB) of the overflow detection unit 133 may be determined assuming that an input signal having the greatest absolute value from among the accumulated input signals is accumulated.

Also, a bit length of an overflow Least Significant Bit (LSB) may be determined based on whether the magnitude of the accumulated input signal is divided into a reference number. Here, the reference number may be predetermined based on a number of levels where the accumulated input signal is divided.

For example, when the reference number is 4, that is, when the magnitude of the accumulated input signal is divided into four levels, the overflow LSB may be determined as 2 bits in length. Specifically, when the magnitude of the input signal is divided into four intervals, the overflow LSB may be 2 bits in length. Thus, as the overflow LSB is positioned in a lower portion of the accumulation unit 131, the accumulation interval may be reduced, so that a magnitude of a signal (hereinafter, referred to as ‘FFT signal’) where the FFT is performed on the input signal may be more finely adjusted.

Also, the overflow detection unit 133 may transmit the counted number of overflows to the signal level determination unit 140.

The signal level determination unit 140 may generate bit shift information (hereinafter, referred to as LSB information) based on the counted number of overflows. Here, the LSB information may be used for adjusting a level of the FFT signal

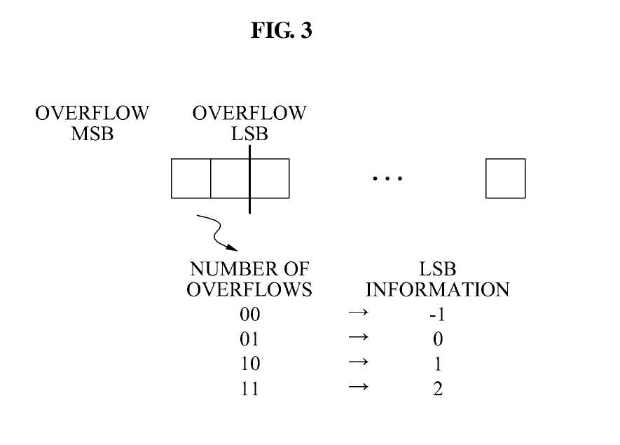

More specifically, as illustrated in FIG. 3, when the overflow detection unit 133 is 2 bits in length, and the LSB information corresponding to a number of overflows from 0 to 3 is respectively predetermined as −1, 0, 1, and 2, the signal level determination unit 140 may transmit, to the signal level adjustment unit 150, the LSB information corresponding to the counted number of overflows. Here, as illustrated in FIG. 3, the number of overflows of 0, 1, 2, and 3 are respectively expressed as ‘00’, ‘01’, ‘10’, and ‘11’.

In this instance, when the counted number of overflows is relatively small, the signal level determination unit 140 may determine the LSB information to have a negative number, and when the counted number of overflows is relatively large, the signal level determination unit 140 may determine the LSB information to have a positive number.

For example, as illustrated in FIG. 3, when the counted number of overflows is 0, the signal level determination unit 140 may transmit, to the signal level adjustment unit 150, the LSB information of ‘−1’ corresponding to the counted number of overflows. Similarly, when the counted number of overflows is 2, the signal level determination unit 140 may transmit, to the signal level adjustment unit 150, the LSB information of ‘1’ corresponding to the counted number of overflows.

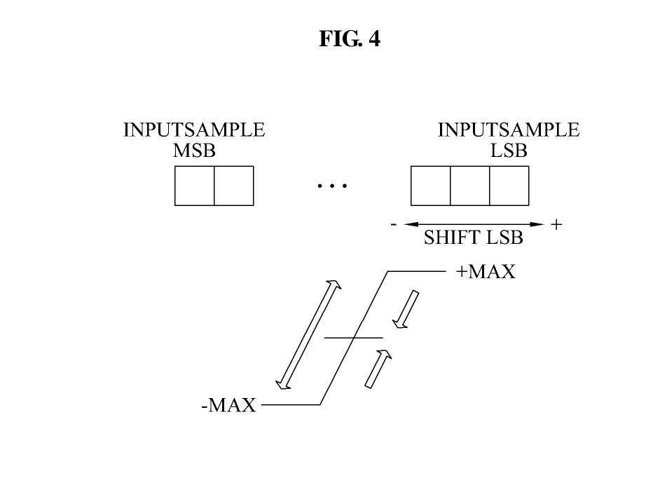

In this instance, when the LSB information is a negative number, the LSB information may be predetermined to have a lower limit negative number. Specifically, referring to FIG. 4, an upper limit of the LSB information may be predetermined within a range where an increased level of the FFT signal does not exceed a predetermined input bit used for signal processing in the signal processing block 160.

Also, when the LSB information is a positive number, the LSB information may be predetermined to have an upper limit positive number. Specifically, referring to FIG. 4, a lower limit of the LSB information may be predetermined within a range where a performance deterioration occurring due to the reduction in the level of the FFT signal is minimized.

The signal level adjustment unit 150 may adjust the level of the FFT signal based on the LSB information transmitted from the signal level determination unit 140.

More specifically, referring to FIG. 4, when the LSB information is a negative number, the signal level adjustment unit 150 may shift, by one bit to a left side, bits of the FFT signal, thereby increasing the level of the FFT signal.

For example, when the LSB information is ‘−1’, the signal level adjustment unit 150 may shift, by one bit to a left side, the bits of the FFT signal, and fill an empty lower bit with 0, thereby increasing the level of the FFT signal.

In this instance, the signal level adjustment unit 150 may adjust the level of the FFT signal, to be increased within a range where the level of the FFT signal does not exceed the predetermined input bit used for the signal processing in the signal processing block 160. Specifically, as illustrated in FIG. 4, the signal level adjustment unit 150 may adjust the level of the FFT signal so that the increased level of the signal does not exceed maximum values such as ‘+max’ and ‘−max’.

Also, when the LSB information is a positive number, the signal level adjustment unit 150 may shift, by two bits to a right side, the bits of the FFT signal, thereby reducing the level of the FFT signal.

Also, when the LSB information is 2, the signal level adjustment unit 150 may shift, by two bits to the right side, the bits of the FFT signal, thereby reducing the level of the FFT signal.

Also, when the LSB information is 0, the signal level adjustment unit 150 may output a signal without adjusting the level of the FFT, thus, outputting a signal identical with an original FFT signal.

The signal processing block 160 may perform, on signals where the signal level is adjusted in the signal level adjustment unit 150, a signal processing such as a channel estimation, a Minimum Mean Square Error (MMSE), a Log-likelihood Ratio (LLR) computation, a de-scrambling, an error correction, and the like.

As described with reference to FIG. 1, the signal level adjustment unit 150 may be positioned in a rear end of the transformation unit 120 to adjust the magnitude of the input signal, so that an amount of a memory resource to be additionally used may be reduced.

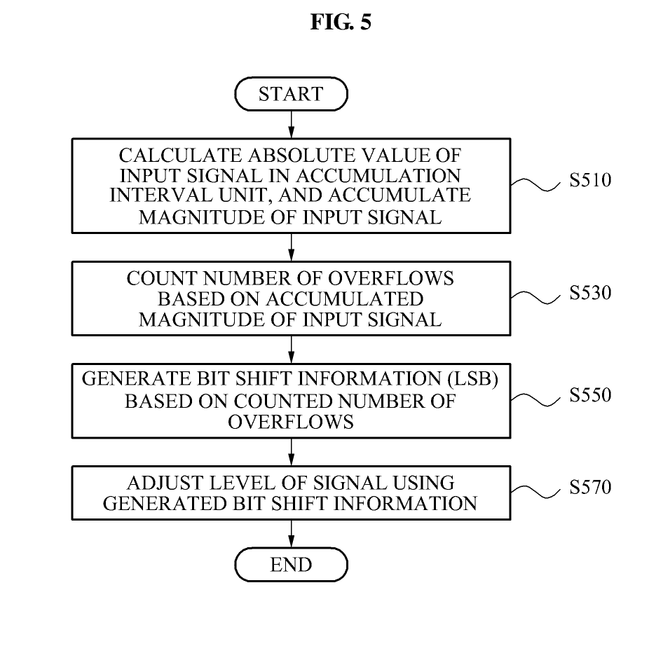

FIG. 5 is a flowchart illustrating operations of a multi-carrier system according to an embodiment of the present invention.

Referring to FIG. 5, in operation S510, the accumulation unit 131 may accumulate a magnitude of an input signal by calculating an absolute value of the input signal in a predetermined accumulation interval unit. For example, the input signal may be a multi-carrier signal.

More specifically, when the accumulation interval is predetermined in a symbol unit, the accumulation unit 131 may accumulate the input signal until bit streams corresponding to a single symbol are received.

The accumulation unit 131 may calculate an absolute value of each of the received signals. In this instance, the accumulation unit 131 may accumulate the absolute value of the input signal for a symbol interval, and calculate an accumulation value for each symbol.

For example, the accumulation unit 131 may accumulate the magnitude of the input signal by adding up absolute values of received signals for each symbol, using an adder. In this instance, the accumulation unit 131 may accumulate the magnitude of the input signal with respect to consecutively inputted overall data, by a predetermined number of the accumulation intervals or for a predetermined period of time.

In operation S530, the overflow detection unit 133 may count a number of overflows based on the accumulated magnitude of the input signal.

For example, the overflow detection unit 133 may increase the number of overflows by 1 unit whenever the magnitude of the input signal exceeds an overall capacity of the accumulation unit 131. For example, the overall capacity of the accumulation unit 131 is a space where the input signal is stored, and may be a bit length.

In operation S550, the signal level determination unit 140 may generate LSB information, that is, bit shift information based on the counted number of overflows.

For example, along with a reduction in the number of overflows, the LSB information having a negative number may be generated, and along with an increase in the number of overflows, the LSB information having a positive number may be generated. Here, an example where the LSB information is generated based on the number of overflows has been already described with reference to FIG. 3, and thus further descriptions thereof will be omitted.

In operation S570, the signal level adjustment unit 150 may adjust a level of a signal based on the generated LSB information. In this instance, the signal level adjustment unit 150 may adjust a level of an FFT signal where an FFT is performed on the input signal in the transformation unit 120.

For example, when the LSB information is a negative number, the signal level adjustment unit 150 may adjust the level of the FFT signal to be increased. In this instance, the signal level adjustment unit 150 may shift, to a left side, bits of the signal where the FFT is performed, thereby increasing the level of the FFT signal. Here, referring to FIG. 4, an increased level of the signal may not exceed maximum values such as ‘+max’ and ‘−max’.

Also, when the LSB information is a positive number, the signal level adjustment unit 150 may adjust the level of the FFT signal, to be reduced. In this instance, the signal level adjustment unit 150 may reduce the level of the FFT signal, by shifting to a right side the bits of the signal where FFT is performed.

Also, when the LSB information is 0, the signal level adjustment unit 150 may output the FFT signal without adjusting the level of the signal where the FFT is performed. Accordingly, the multi-carrier system 100 may adjust the level of the signal where the FFT is performed, by only performing a bit shift operation without using a multiplier or a divider, thereby reducing an amount of a hardware resource to be used.

As described above, when receiving the multi-carrier, the level of the signal transformed to the frequency domain may be adjusted by accumulating the magnitude of the input signal, however, this is merely an example. Thus, even when transmitting the multi-carrier, the level of the signal may be adjusted by accumulating the magnitude of the signal.

Also, the input signal may be accumulated based on the absolute value of the input signal, however, this is merely an example. Thus, the input signal may be accumulated based on power, a signal to ratio (SNR), and the like of the input signal other than the absolute value of the input signal.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A multi-carrier system, comprising:
a transformation unit to transform an input signal from a time domain to a frequency domain;
a signal accumulation unit to accumulate a magnitude of the input signal in a predetermined accumulation interval unit, and to count a number of overflows based on the accumulated magnitude of the input signal;
a signal level determination unit to generate bit shift information for adjusting a level of the transformed input signal based on the counted number of overflows; and
a signal level adjustment unit to adjust the level of the transformed input signal based on the generated bit shift information.

2. The multi-carrier system of claim 1, wherein the signal accumulation unit comprises:
an accumulation unit to accumulate the magnitude of the input signal in the predetermined accumulation interval unit; and
an overflow detection unit to count the number of overflows obtained when the accumulated magnitude of the input signal exceeds an overall capacity of the accumulation unit.

3. The multi-carrier system of claim 1, wherein the signal accumulation unit accumulates the magnitude of the input signal using a single adder.

4. The multi-carrier system of claim 1, wherein the signal level determination unit generates the bit shift information to enable the bit shift information to have a negative number along with a reduction in the counted number of overflows, and to enable the bit shift information to have a positive number along with an increase in the counted number of overflows.

5. The multi-carrier system of claim 1, wherein the signal level adjustment unit adjusts the level of the transformed input signal to be increased when the bit shift information has a negative number.

6. The multi-carrier system of claim 5, wherein the signal level adjustment unit adjusts the level of the transformed input signal to be increased by shifting, to a left side, the transformed input signal by bits corresponding to the bit shift information.

7. The multi-carrier system of claim 1, wherein the signal level adjustment unit adjusts the level of the transformed input signal to be reduced when the bit shift information has a positive number.

8. The multi-carrier system of claim 7, wherein the signal level adjustment unit adjusts the level of the transformed input signal to be reduced by shifting, to a right side, the transformed input signal by bits corresponding to the bit shift information.

9. The multi-carrier system of claim 1, wherein the signal level adjustment unit outputs the level of the transformed input signal without adjusting the level of the transformed input signal when the bit shift information is 0.

10. The multi-carrier system of claim 1, wherein the signal accumulation unit calculates an absolute value of each of the input signals inputted in the predetermined accumulation interval unit, and accumulates, as the magnitude of the input signal, the calculated absolute value of each of the input signals.

11. The multi-carrier system of claim 1, wherein the transformation unit transforms the input signal from the time domain to the frequency domain by performing a fast Fourier transform (FFT) on the input signal, and the signal level adjustment unit adjusts a level of an FFT signal where the FFT is performed on the input signal.

12. The multi-carrier system of claim 1, wherein the signal accumulation unit, the signal level determination unit, and the signal level adjustment unit are positioned subsequent to the transformation unit.

13. The multi-carrier system of claim 1, wherein the accumulation interval is predetermined based on a structure of a pilot signal or a preamble signal.

14. The multi-carrier system of claim 1, wherein the signal accumulation unit accumulates the magnitude of the input signal in the predetermined accumulation interval unit, starting from an accumulation starting point in time, and the accumulation starting point in time is predetermined based on a frame structure of the input signal and the accumulation interval.

15. A method for receiving a multi-carrier, the method comprising:
transforming an input signal from a time domain to a frequency domain;
accumulating a magnitude of the input signal in a predetermined accumulation interval unit;
counting a number of overflows based on the accumulated magnitude of the input signal;
generating bit shift information for adjusting a level of the transformed input signal based on the counted number of overflows; and
adjusting the level of the transformed input signal based on the generated bit shift information.

16. The method of claim 15, wherein the accumulating comprises:
calculating an absolute value of each of the input signals inputted in the predetermined accumulation interval unit; and
accumulating, as the magnitude of the input signal, the calculated absolute value of each of the input signals.

17. The method of claim 16, wherein the accumulation interval is predetermined in a symbol unit, and the calculating calculates the absolute value of the input signal in the symbol unit.

18. The method of claim 15, wherein the transforming transforms the input signal from the time domain to the frequency domain by performing an FFT on the input signal.

19. The method of claim 18, wherein the adjusting adjusts a level of an FFT signal where the FFT is performed on the input signal.

20. The method of claim 15, wherein the adjusting adjusts the level of the transformed input signal by shifting, to a left side or a right side, the transformed input signal based on the generated bit shift information.
